(19) United States
(12) Patent Application Publication
(10) Pub. No.: US 2010/0050709 A1
(43) Pub. Date: Mar. 4, 2010

(54) Security Device for Mobile Retail Cart

(76) Inventor: Keith Neville, Notts (GB)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/517,158

(22) PCT Filed: Dec. 2, 2006
(86) PCT No.: PCT/GB07/04599

§ 371 Date: Jun. 2, 2009

(30) Foreign Application Priority Data
Dec. 2, 2006 (GB) 0624142.6

(51) Int. Cl. E05B 47/00; B65D 55/14; G08B 13/14; G06K 5/00; G06F 19/00

(52) U.S. Cl. 70/158; 70/277; 340/572.1; 340/568.1; 235/382; 235/385

(57) ABSTRACT

A security device (10) is provided for a mobile retail cart (12) having a lockable compartment (16) for storing goods to be sold. The security device comprises an electronic lock unit for securing a closure (14) of the compartment, the electronic lock unit including means (21) for reading an electronic key device and means (23) for locking and unlocking the closure in response thereto. A memory records data read from the electronic key device and information relating to the locking and/or unlocking of the compartment. The security device is suitable for use as an airline security device for a retail cart for storing goods to be sold on board an aircraft.

The present invention relates to a security device for a mobile retail cart. In particular, but not exclusively, the security device provides means for controlling access to contents of an airline retail cart and monitoring of the contents of the cart.

Airlines are increasingly looking at in-flight retail as an additional source of revenue. Typically carts (or trolleys as they are also known) are packed with goods (e.g. duty free products) at a warehouse, or a kitchen in the case of food and beverage carts for in-flight refreshments. The carts are delivered to the aircraft often by a third party logistics company, and usually passing through additional security checks prior to arriving at the aircraft.

During a flight, the cabin crew open the carts, sell the goods, and close and lock the carts at the end of the flight. The operation—opening, selling and closing the carts—is repeated during subsequent flights. Carts can be used, in the case of short haul operations, on ten or more flights in a single day.

Although there are numerous manual- and computer-based systems that allow the recording of in-flight sales and the monitoring of stock, the method of controlling access to the carts remains very basic.

Typically the carts are secured with identical padlocks and all personnel requiring access to the carts are issued with keys. Keys are issued to warehouse staff, outside caterers, security companies, cabin crew, customs etc.

The keys are standard across an airline operation. It is not unusual for keys to be lost within days of a new set of locks being issued. Keys may also be stolen (by airline personnel or otherwise). The loss of keys can result in a failure of the integrity of the system because an individual with a key may have access to any cart within the airline operation. There is therefore a danger that a key falling into the hands of an unauthorised person could be used to open (and potentially steal from) any cart of the airline. Due to the number of parties accessing the carts, and the fact that it is very difficult to maintain the integrity of the system, inventory losses are high.

Furthermore the identification of the cause of a loss, and identifying the culprit(s) responsible for a loss and the time a loss occurred, is exceptionally difficult.

A numbered seal may be provided on the cart/padlock which, when broken, provides evidence of tampering. However, this provides no indication as to when and by whom the tampering occurred.

There is therefore a need for improving the security of airline retail systems. The present invention has been devised with the foregoing in mind.

According to the present invention there is provided a security device for a mobile retail cart having a lockable compartment for storing goods to be sold, the security device comprising an electronic lock unit for securing a closure of the compartment, the electronic lock unit including means for reading an electronic key device and means for locking and unlocking the closure in response thereto, and memory means for recording data read from the electronic key device and information relating to the locking and/or unlocking of the compartment. Preferably, the security device is an airline security device for a retail cart for storing goods to be sold on board an aircraft.

It is an advantage that the security device is a self-contained unit that can be retrofitted to existing carts or incorporated into new carts. The security device provides an improvement in system integrity compared with the conventional padlock system as the management of electronic keys is much easier than the management of mechanical keys.

Preferably, the means for reading an electronic key device is a smart card reader for reading information from a smart card. Smart cards are highly portable and inexpensive to manufacture and thus replace if necessary. Each smart card can be provided with a unique identity and thus avoiding the insecure system whereby every member of personnel carries identical keys.

In an embodiment, the means for locking and unlocking the closure is an electronically controlled bolting mechanism. Conveniently, an electromagnetic locking mechanism is used. In a preferred embodiment, the electromagnetic locking mechanism comprises a solenoid.

A sensor may be provided for sensing each time the closure is locked and unlocked.

Preferably, the memory means stores information indicating whether a smart card is valid or invalid. Means may be provided for restricting or denying access to the goods stored in the cart by blocking an invalid smart card. Validating and invalidating smart cards provides an easy and efficient way of managing who may and may not access the contents of a cart.

The information relating to the locking and/or unlocking of the compartment may include one or more of the identity of a smart card inserted into the smart card reader, the time of unlocking and/or locking of the compartment, and whether an attempt to unlock or lock the compartment was successful. This allows an airline to keep track of the stock and smart card usage in a simple manner.

Preferably, the security device further comprises an RFID scanner for scanning RFID tag identifiers provided on goods stored within the lockable compartment of the cart. The memory means may additionally store information from the RFID scanner. The security device may further comprise means for checking the stock of goods within the compartment to confirm the presence or absence of each item. The means for checking the stock may be used to provide an indication of whether any goods have been erroneously removed without a corresponding sale.

Such monitoring of stock minimises the retail goods that are lost/stolen. It also provides an improved management of sales by facilitating a determination of how much stock is required in a cart, and allowing stock to be replenished as and when necessary.

In embodiments of the invention, the RFID scanner is further operable for scanning an RFID label sealing an envelope to identify the presence of the envelope or cash bag, wherein opening of the envelope destroys the RFID label. The envelope or cash bag may contain, for example, cash and credit card receipts, or a document comprising information relating to the goods, such as a stock inventory or the like.

Advantageously, the combination of using smart card & RFID technologies provides a convenient and secure method of controlling access to carts and monitoring of cart contents.

In an embodiment, a processing device may be provided for downloading and/or analysing information from the security device. The processing device may be configured to disable access to the cart if any goods have been erroneously removed without a corresponding sale. The processing device may be configured to analyse the downloaded data to provide an indication of any one or more of: goods removed from the cart, whether the removal was authorised or unauthorised by comparison with a record of the goods sold, the identification of the smart cart that unlocked the cart for removal of an item of goods, the time of unlocking and/or locking of the closure, whether any invalid attempts to lock/unlock the closure were made, and whether any access to the cart was disabled.

Embodiments of the invention will now be described by way of examples with reference to the drawings, in which:

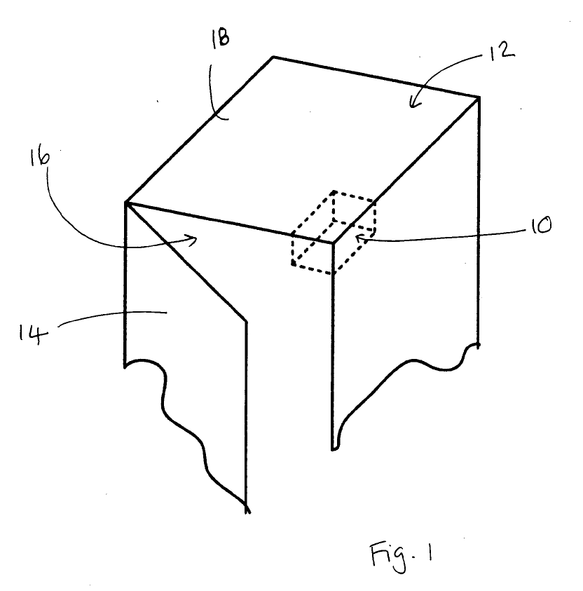

FIG. 1 is a isometric view of the security device according to any embodiment of the present invention in position in an airline goods cart.

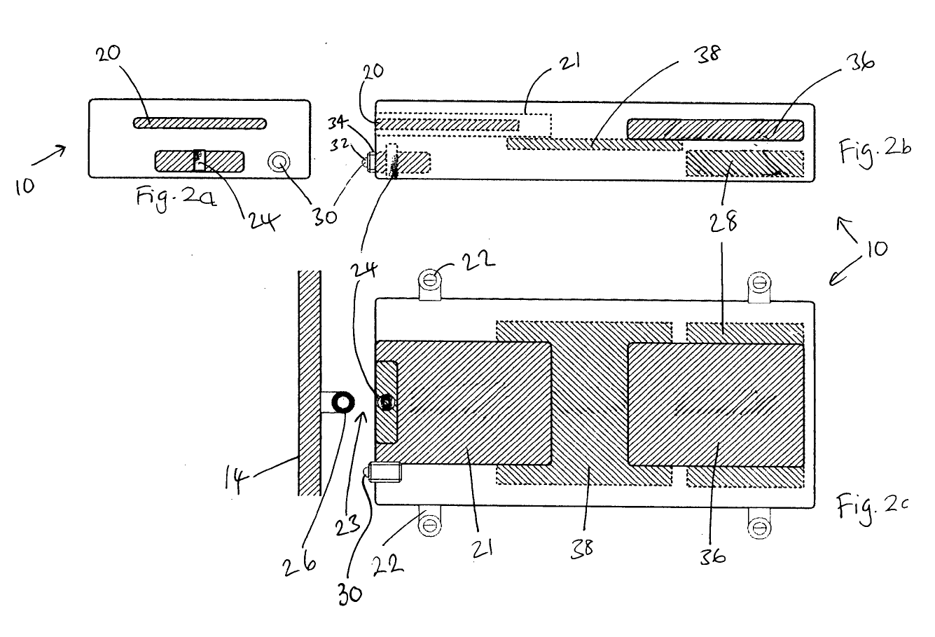

FIG. 2c is an external front view of the embodiment of FIGS. 2a and 2b; and

FIG. 2b is an internal side view of the embodiment shown in FIG. 2a;

FIG. 2c is an internal top view of the airline security device according to an embodiment of the present invention;

Referring to FIG. 1, an airline security system or ‘SmartSecure™’ device 10 is shown in position inside an airline retail cart or trolley 12. Positioning the device 10 within the trolley 12 minimises the risk of the system 10 being tampered with. The trolley 12 has a lockable door 14 and a compartment 16 in which goods (e.g. duty free products or meal/beverage refreshments) can be stored. The security device 10 is located towards the front of the cart 12, and part of the security device 10 can contact the door 14 when closed to achieve locking. In the embodiment shown, the security device 10 is located towards the upper surface 18 of the cart 12, this being a convenient height for personnel to access the security device 10.

Referring to FIGS. 2a to 2c, the details of the security device 10 are shown. FIG. 2a shows the front face of the security device 10. A smart card reader 21 is provided, for reading data from a smart card (not shown) belonging to a member of airline personnel, warehouse staff, outside caterers, security companies, cabin crew, customs etc. A slot 20 is provided within the smart card reader 21, into which a smartcard can be inserted. A corresponding slot (not shown) is provided in the door 14 of the cart 12.

An electromagnetic lock 23 is provided to secure the door 14 to the security device 10 (which is permanently fixed within the interior of the cart 12 with fixings 22). The electromagnetic lock comprises a solenoid 24 provided within the security device 10 that is receivable within a lock bracket 26 provided on the internal surface of the door 14. A power source, conveniently a battery 28, is provided for powering the components of the security device 10.

A sensor 30 is provided on the front face of the security device 10, protruding therefrom such that it is activated when the door 14 is either opened or closed (or locked or unlocked). In the embodiment shown, the door sensor 30 comprises a limit switch device having a central button 32 that can be depressed into a housing 34. Movement of the button 32 within the housing 34 produces an electrical signal to be produced, which is registered and recorded by a central processing unit (CPU) 38.

The CPU may comprise a memory for storing various information including, but not limited to:
Data read by the smart card reader 21, including the identity of the smart card and the time of locking/unlocking of the cart 12;
A list of valid smart cards;
A record of valid and/or invalid access attempts;
A list of goods stored within the cart 12;
A record of goods removed from the cart 12;
An indication of whether removal of goods was authorised (i.e. there was a valid sale) or unauthorised (i.e. there was no corresponding sale);

In order to track the goods sold/removed from the cart 12, or returned to if there is an exchange of goods for example, an RFID scanner 36 is provided. The scanner 36 being configured to scan RFID tag identifiers provided on the goods items within the cart 12. As indicated in the list above, the CPU 38 stores a list of what items should be stocked within the cart 12, and the RFID scanner 36 can be programmed only to scan for items from that list (and thus not register items present in other carts nearby).

The CPU 38 may also be configured to analyse the data recorded to enable up-to-date monitoring of stock sold and/or removed, by whom and at what time. The CPU 38 may also be configured to disable access to particular smart cards if it is determined that the owner of that smart card performed an unauthorised transaction.

Alternatively, the analysis may be performed by a separate processing device after the flight, at a central processing station that can store information and monitor a number of different carts 12.

In order to download data from the CPU 38, and upload inventory data and smart card validity data to the device 10, communication between the central processing station and the security device 10 is enabled. Although not shown in the Figures, this is preferably achieved by providing a port on the device 10 into which a cable/connector can be inserted, the cable/connector being connectable to the central processing station. Alternatively, data/information could be communicated by wireless means such as, for example, via radio signals, Bluetooth interfaces, infrared communication etc.

Before use during a flight, a cart 12 will be loaded with relevant goods/stock. The goods will each be provided with an RFID tag identifier. As the cart 12 passes through the packing station (e.g. a kitchen, a bonded warehouse etc.) the memory of the security device 10 is updated (from a processing device with the packing station) with a list of valid smart cards and the RFID tag identifiers of the items in the cart 12. At the same time, activity logs (relating to access to the cart 12 during a previous inbound flight) are downloaded to the packing station processing device from the security device 10. Lost or stolen smart cards are deleted from the security device 10, thereby removing the cardholder's ability to access the contents of the cart 12.

To access the contents of the cart 12, a cardholder inserts their smart card into the slot in the door 14 of the cart 10 and thus into the slot 20 of the smart card reader 21. If the card is valid (i.e. if it is in the list of valid—i.e. acceptable—cards stored in the memory of the security unit 10), the solenoid 24 is activated, unlocking the cart 12. Both successful and unsuccessful access attempts are logged by the memory of the CPU 38.

Opening or closing (or locking/unlocking) the door 14 triggers a “stock check” by the CPU 38 of the security unit 10. The unit 10 polls the RFID tags in the cart 10, confirming the presence or absence of each tagged item. The CPU 38 may compare the stock check against the theoretical list of stock, to see whether all sales are accounted for, or if any unauthorised removals of stock from the cart 12 have occurred. In addition, or alternatively, the information is downloaded from the memory of the security device 10 upon return to the packing station for further analysis.

As a result of the information captured it is possible to determine:
Who accessed the cart 10;
When the cart 10 was accessed;
What items were removed from the cart 10 during each session (by comparing the opening and closing stock check data); and
Whether any invalid access attempts were made.

The memory log can be compared to sales activity to determine which items were removed without a corresponding sale.

In addition to the goods in the cart 10, a sealed envelope or similar container may be placed inside the cart, the envelope containing information concerning the goods in the cart (e.g. inventory data, value of goods etc.). The container may be a cash bag containing, for example, cash and credit card receipts. In a particularly convenient arrangement, the container, envelope or cash bag may be sealed with a seal that contains an RFID label. This enables the container to be tracked by the RFID scanner (in the same way as the goods). Also, the RFID label seal will be destroyed if the container is opened, thereby providing evidence of tampering.

The ability to disable a specific smartcard's access to the cart 10, combined with the ability to record both access and items removed from the cart 10, prevents both unauthorised access to the cart 10 and also deters against theft by authorised personnel.

It will be appreciated by persons skilled in the art that various modifications may be made to the above described embodiments without departing from the scope of the present invention. For example, the security device could be fitted in mobile retail units other than those used in aircraft (e.g. on trains and other public transport or in carts taken around hospital wards etc.). Some retail carts are provided with doors at both ends of the cart, or openings elsewhere on the cart. For such carts, a plurality of security devices could be fitted—one for each door/opening, or a single device could respond to a plurality of card readers, solenoids, door sensors in communication with that single security device. Furthermore, instead of a smart card, other personal identification devices (and corresponding data readers/scanners) could be used (e.g. security token, biometric information etc.) in conjunction with a corresponding reader for reading the information therefrom.

1. A security device for a mobile retail cart having a lockable compartment for storing goods to be sold, the security device comprising:
an electronic lock unit for securing a closure of said compartment, the electronic lock unit including means for reading an electronic key device and means for locking and unlocking said closure in response thereto; and
memory means for recording data read from said electronic key device and information relating to the locking and/or unlocking of the compartment.

2. The security device of claim 1, wherein the means for reading an electronic key device is a smart card reader for reading information from a smart card.

3. The security device of claim 1, wherein the means for locking and unlocking the closure comprises an electromagnetic locking mechanism.

4. The security device of claim 3, wherein the electromagnetic locking mechanism comprises a solenoid.

5. The security device of claim 1, further comprising a sensor for sensing each time the closure is locked and unlocked.

6. The security device of claim 1, wherein the memory means stores information on whether a smart card is valid or invalid.

7. The security device of claim 6, further comprising means for restricting or denying access to the goods stored in the cart by blocking an invalid smart card.

8. The security device of claim 1, wherein the information relating to the locking and/or unlocking of the compartment includes one or more of: the identity of a smart card inserted into the smart card reader;
the time of unlocking and/or locking of the compartment; and
whether an attempt to unlock or lock the compartment was successful.

9. The security device of claim 1, further comprising an RFID scanner for scanning RFID tag identifiers provided on goods stored within the lockable compartment of the cart.

10. The security device of claim 9, wherein the memory means additionally stores information from the RFID scanner.

11. The security device of claim 9, further comprising means for checking the stock of goods within the compartment to confirm the presence or absence of each item.

12. The security device of claim 11, wherein the means for checking the stock provides an indication of whether any goods have been erroneously removed without a corresponding sale.

13. The security device of any of claim 9, wherein the RFID scanner is further operable for scanning an RFID label sealing a container, envelope or cash bag to identify the presence thereof, wherein opening of the container, envelope or cash bag destroys the RFID label.

14. The security device of claim 1, the security device being an airline security device for a retail cart for storing goods to be sold on board an aircraft.

15. A retail cart comprising a lockable compartment for storing goods to be sold on board an aircraft and a security device comprising:
an electronic lock unit for securing a closure of said compartment, the electronic lock unit including means for reading an electronic key device and means for locking and unlocking said closure in response thereto; and
memory means for recording data read from said electronic key device and information relating to the locking and/or unlocking of the compartment.

16. An airline retail shopping system comprising:
a retail cart with a lockable compartment for storing goods to be sold on board an aircraft;
a security device comprising an electronic lock unit for securing a closure of said compartment, the electronic lock unit including means for reading an electronic key device and means for locking and unlocking said closure in response thereto: and memory means for recording data read from said electronic key device and information relating to the locking and/or unlocking of the compartment; and
a processing device for downloading and/or analysing information from the security device.

17. The system of claim 16, wherein the processing device is configured to disable access to the cart if any goods have been erroneously removed without a corresponding sale.

18. The system of claim 16, wherein the processing device is configured to analyse the data to provide an indication of any one or more of:
goods removed from the cart;
whether the removal was authorised or unauthorised by comparison with a record of the goods sold;
the identification of the smart cart that unlocked the cart for removal of an item of goods;
the time of unlocking and/or locking of the closure;
whether any invalid attempts to lock/unlock the closure were made; and whether any access to the cart was disabled.

19-20. (canceled)
